(19) United States
(12) Patent Application Publication
(10) Pub. No.: US 2014/0226531 A1
(43) Pub. Date: Aug. 14, 2014

(54) Multicast support for EVPN-SPBM based on the mLDP signaling protocol

(71) Applicant: TELEFONAKTIEBOLAGET L M ERICSSON (PUBL), (US)

(72) Inventors: János Farkas, Kecskemet (HU); David Ian Allan, San Jose, CA (US); Panagiotis Saltsidis, Stockholm (SE); Evgeny Tantsura, Palo Alto, CA (US)

(73) Assignee: TELEFONAKTIEBOLAGET L M ERICSSON (PUBL), Stockholm (SE)

(21) Appl. No.: 13/889,973

(22) Filed: May 8, 2013

Related U.S. Application Data
(60) Provisional application No. 61/764,932, filed on Feb. 14, 2013.

(51) Int. Cl. H04L 12/24

(52) U.S. Cl. CPC H04L 41/0893
USPC 370/256

(57) ABSTRACT

A method implemented by a network element connected to a core network and an edge network, the network element providing multicast support across the core network including the construction and advertisement of shared trees in the core network, the method comprising the steps of: collecting network information including multicast distribution tree (MDT) participation information for the network element to enable support of multicast groups that transit the core network and identify a set of MDTs for the network element to participate in; executing a shared name construction algorithm to uniquely identify each of the set of MDTs on the basis of source and receiver sets; and executing join and leave operations using the unique identifier according to the shared name construction algorithm of a MDT to register interest in or establish connectivity for the MDT as it involves the network element.

### CROSS REFERENCE TO RELATED APPLICATION

The present application claims priority from U.S. Provisional Patent Application No. 61/764,932, filed on Feb. 14, 2013.

### FIELD OF THE INVENTION

Embodiments of the invention relate to the field of computer networking; and more specifically, to multicasting support for 802.1 and Ethernet Virtual Private Network (EVPN).

### BACKGROUND

The IEEE 802.1aq standard (also referred to 802.1aq hereinafter), published in 2012, defines a routing solution for the Ethernet. 802.1aq is also known as Shortest Path Bridging or SPB. 802.1aq enables the creation of logical Ethernet networks on native Ethernet infrastructures. 802.1aq employs a link state protocol to advertise both topology and logical network membership of the nodes in the network. Data packets are encapsulated at the edge nodes of the networks implementing 802.1aq either in mac-in-mac 802.1ah or tagged 802.1Q/p802.1ad frames and transported only to other members of the logical network. Unicast and multicast are also supported by 802.1aq. All such routing is done via symmetric shortest paths. Multiple equal cost shortest paths are supported. Implementation of 802.1aq in a network simplifies the creation and configuration of the various types of network including provider networks, enterprise networks and cloud networks. The configuration is comparatively simplified and diminishes the likelihood of error, specifically human configuration errors. 802.1 aq networks emulate virtual local area networks (VLANs) as virtualized broadcast domains using underlying network multicast. When transporting such traffic over MPLS based EVPN carrier networks, only edge based replication exists as a mechanism for multicast emulation. No currently specified mechanism exists for EVPN to permit properly scoped network based multicast to be used.

### SUMMARY

A method implemented by a network element connected to a core network and an edge network, the network element providing multicast support across the core network including the construction and advertisement of shared trees in the core network, the method comprising the steps of: collecting network information including multicast distribution tree (MDT) participation information for the network element to enable support of multicast groups that transit the core network and identify a set of MDTs for the network element to participate in; executing a shared name construction algorithm to uniquely identify each of the set of MDTs on the basis of source and receiver sets; and executing join and leave operations using the unique identifier according to the shared name construction algorithm of a MDT to register interest in or establish connectivity for the MDT as it involves the network element.

A method of a process is described for construction of shared trees on a control plane for a set of designated forwarders (DFs). The process is performed at a provider edge (PE) where the PE may have a pre-existing list of multicast memberships and a combination of network information that has already been distributed by both border gateway protocol (BGP) and intermediate system—intermediate system (IS-IS). The method comprises the steps of determining, by the PE, the set of designated forwarders (DFs) that the PE needs to multicast to for each I-component service identifier (I-SID). The resulting set of DFs is processed to generate unique names for the multicast groups or multicast distribution trees (MDTs) for each set of DFs using a shared name construction algorithm. Each new named set of multicast groups is compared with a corresponding named set of multicast groups to identify new and missing MDTs. Leave operations are issued for each missing MDT. Join operations for each new MDT that was detected in the comparison are also issued. A forwarding equivalency class (FEC) is encoded using route target, source DF, ranked destination DF for point to multi-point (p2 mp) trees and route target, sorted destination list for multi-point to multi-point (mp2 mp) trees. Finally, the data plane is programmed to map each I-SID to the associated MDT.

A network element is described that is connected to a core network and an edge network. The network element provides multicast support across the core network including the construction and advertisement of shared trees in the core network. The network element comprises a network processor configured to execute a control plane interworking function and a control plane multicast function. The control plane interworking function is configured to map network information between the core network and the edge network. The control plane multicast function is configured to collect network information including multicast distribution tree (MDT) participation information for the network element to enable support of multicast groups that transit the core network and identify a required set of MDTs for the network element to participate in and to execute a shared name construction algorithm to uniquely identify each of the set of MDTs on the basis of source and receiver sets. The control plane multicast function is configured to execute join and leave operations using the unique identifier according to the shared name construction algorithm of a MDT to register interest in or establish connectivity for the MDT as it involves the network element.

A network element is described that functions as a provider edge (PE) to implement a process for construction of shared trees on a control plane by a set of designated forwarders (DFs). The PE may have a pre-existing list of multicast memberships and a combination of network information that has already been distributed by both border gateway protocol (BGP) and intermediate system—intermediate system (IS-IS). The provider edge comprises a network processor configured to execute an IS-IS module, a BGP module, a control plane interworking function and a control plane multicast function. The IS-IS module is configured to implement IS-IS for a SPBM. The BGP module is configured to implement BGP for an EVPN. The control plane interworking function is configured to correlated IS-IS and BGP data. The control plane multicast function module is configured to determine a set of designated forwarders (DFs) that the PE needs to multicast to for each I-component service identifier (I-SID), to process the resulting sets of DFs to generate unique names for the multicast groups or multicast distribution trees (MDTs) for each set of DFs using a shared name construction algorithm, to compare each new named set of multicast groups with a corresponding named set of multicast groups to identify new and missing MDTs, to execute leave operations for each missing MDT, to execute join operations for each new MDT that was detected in the comparison, to encode a forwarding equivalency class (FEC) using route target, source DF, ranked destination DF for point to multi-point (p2 mp) trees and route target, sorted destination list for multi-point to multi-point (mp2 mp) trees, and to program the data plane to map each I-SID to the associated MDT.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram of one embodiment of an example EVPN—SPBM network implementing enhanced multicast using mLDP.

FIG. 2A is a diagram of one embodiment of a process for determining shared trees on the control plane for sending designated forwarders.

FIG. 2B is a diagram of one embodiment of a process for determining shared trees on the control plane for receiving designated forwarders.

FIG. 2C is a diagram of one embodiment of the process for determining service specific trees on the control plane for sending designated forwarders.

FIG. 2D is a diagram of one embodiment of the process for determining service specific trees on the control plane for receiving designated forwarders.

FIG. 2E is a flowchart of one embodiment of a general multicast support process.

FIG. 3 is a diagram of one embodiment of a PE implementing the 802.1aq over EVPN and the improved multicasting.

FIG. 4 illustrates an example a network element that may be used to implement an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The operations of the flow diagrams will be described with reference to the exemplary structural embodiments illustrated in the Figures. However, it should be understood that the operations of the flow diagrams can be performed by structural embodiments of the invention other than those discussed with reference to Figures, and the embodiments discussed with reference to Figures can perform operations different than those discussed with reference to the flow diagrams.

The techniques shown in the figures can be implemented using code and data stored and executed on one or more electronic devices (e.g., an end station, a network element, etc.). Such electronic devices store and communicate (internally and/or with other electronic devices over a network) code and data using non-transitory machine-readable or computer-readable media, such as non-transitory machine-readable or computer-readable storage media (e.g., magnetic disks; optical disks; random access memory; read only memory; flash memory devices; and phase-change memory). In addition, such electronic devices typically include a set of one or more processors coupled to one or more other components, such as one or more storage devices, user input/output devices (e.g., a keyboard, a touch screen, and/or a display), and network connections. The coupling of the set of processors and other components is typically through one or more busses and bridges (also termed as bus controllers). The storage devices represent one or more non-transitory machine-readable or computer-readable storage media and non-transitory machine-readable or computer-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software, that communicatively interconnects other equipment on the network (e.g., other network elements, end stations, etc.). Some network elements are “multiple services network elements” that provide support for multiple networking functions (e.g., routing, bridging, switching, Layer 2 aggregation, session border control, multicasting, and/or subscriber management), and/or provide support for multiple application services (e.g., data, voice, and video). Subscriber end stations (e.g., servers, workstations, laptops, palm tops, mobile phones, smart phones, multimedia phones, Voice Over Internet Protocol (VoIP) phones, portable media players, GPS units, gaming systems, set-top boxes (STBs), etc.) access content/services provided over the Internet and/or content/services provided on virtual private networks (VPNs) overlaid on the Internet. The content and/or services are typically provided by one or more end stations (e.g., server end stations) belonging to a service or content provider or end stations participating in a peer to peer service, and may include public web pages (free content, store fronts, search services, etc.), private web pages (e.g., username/password accessed web pages providing email services, etc.), corporate networks over VPNs, IPTV, etc. Typically, subscriber end stations are coupled (e.g., through customer premise equipment coupled to an access network (wired or wirelessly)) to edge network elements, which are coupled (e.g., through one or more core network elements to other edge network elements) to other end stations (e.g., server end stations).

The following Acronyms are used herein and provided for reference: BCB—Backbone Core Bridge; BEB—Backbone Edge Bridge; BGP—Border Gateway Protocol; CP—Control Plane; BU—Broadcast/Unknown; CE—Customer Edge; C-MAC—Customer/Client MAC Address; DF—Designated Forwarder; ESI—Ethernet Segment Identifier; EVI—E-VPN Instance; EVN—EVPN Virtual Node; EVPN—Ethernet VPN; I-SID—I Component Service ID; ISIS-SPB—IS-IS as extended for SPB; LAG—Link Aggregation Group; mLDP—multicast label distribution protocol; MPLS—Multiprotocol Label Switching; MP2MP—Multipoint to Multipoint; MVPN: Multicast VPN; NLRI—Network Layer Reachability Information; OUI—Organizationally Unique ID; PBB-PE—Co located BEB and PE; PBBN—Provider Backbone Bridged Network; PE—Provider Edge; P2MP—Point to Multipoint; P2P—Point to Point; RD—Route Distinguisher; RPFC—Reverse Path Forwarding Check; RT—Route Target; SPB—Shortest Path Bridging; SPBM—Shortest Path Bridging MAC Mode; and VID—VLAN ID.

The embodiments of the present invention provide a method and system to construct multicast group names for both shared I-SID trees and service specific trees and the registration methods for multicast label distribution protocol (mLDP) for each. This method and system leverage BGP flooding of all relevant information for all of the PEs to have sufficient information to determine the set of shared or service specific trees required and the actions that each PE needs to take for their part in maintenance of that set. The method and system utilizes existing standardized protocols and state machines that are augmented to carry some additional information. This is a significant improvement over simply gleaning the information via observing all PBBN traffic. The solution to actualize this method is an algorithmic generation of multicast distribution tree names such that all potential members of a multicast group or shared tree supporting multiple groups (both senders and receivers) can communicate and set up multicast distribution trees (MDTs) without requiring a separate mapping system, or a priori configured tables. All the required MDTs and associated identifiers can be inferred from BGP and IS-IS exchange. This method and system is able to provide unique and unambiguous identification of a multicast distribution tree. This method and system also minimizes churn for joins and leaves of the resulting MDTs. A shared tree is one that can serve more than one multicast group when the said set of multicast groups has a common topology in the domain of the shared tree. In 802.1aq an I-SID identifies a multicast group. mLDP provides the ability to define application specific naming conventions of arbitrary length, which facilitates the use of such a mechanism. mLDP is document in RFC 6388. mLDP permits the creation of P2MP and MP2MP MDTs.

The multicast forwarding equivalence class (FEC) permits arbitrary structured or opaque tokens to be constructed for multicast group naming. In one embodiment, the name of each MDT is a unique algorithmically generated and ranked set of receiver PEs (e.g., for MP2MP trees). In other embodiments, the unique name of the MDT is the source and an algorithmically generated and ranked set of receiver PEs (e.g., for P2MP trees). For service specific trees, the name can be the service name plus whatever additional information is required to ensure its uniqueness. The additional information can be the virtual private network identifier (VPN ID) for P2MP and MP2MPMDTs or the source for P2MP trees.

The embodiments of the present invention overcome the disadvantages of the prior art. SPBM over EVPN is effectively a VPN at the EVPN layer that carries potentially a large number of layer 2 VPNs. Therefore use of what is termed an “inclusive tree,” which is a MDT common to all L2VPNs in the EVPN VPN, would be highly inefficient. Many receivers around the edge of the EVPN network would receive multicast frames for which there was no local recipient, so they would simply be discarded. Such traffic could severely impact the network bandwidth availability and tax the PEs. Edge replication permits a more targeted approach to multicast distribution, but is inefficient from the point of view of the bandwidth consumed, as the number of recipients for a given L2VPN may be much larger than the set of uplinks from the edge replication point, so many copies of the same frame would transit individual links. The embodiments solve these problems by providing a method an system of that provide more granular and efficient network based multicast replication in an MPLS-EVPN network that efficiently integrates into any SPBM-EVPN interworking function.

In IEEE 802.1aq networks, a link state protocol is utilized for controlling the forwarding of Ethernet frames on the network. One link state protocol, the Intermediate System to Intermediate System (IS-IS), is used in 802.1aq networks for advertising both the topology of the network and logical network membership.

802.1aq has two modes of operation. A first mode for Virtual Local Area Network (VLAN) based networks is referred to as shortest path bridging VID (SPBV). A second mode for MAC based networks is referred to as shortest path bridging MAC (SPBM). Both SPBV and SPBM networks can support more than one set of equal cost forwarding trees (ECT sets) simultaneously in the data plane. An ECT set is commonly associated with a number of shortest path VLAN identifiers (SPVIDs) forming an SPVID set for SPBV, and associated 1:1 with a Backbone VLAN ID (B-VID) for SPBM.

According to 802.1aq MAC mode, network elements in the provider network are configured to perform multipath forwarding traffic separated by B-VIDs so that different frames addressed to the same destination address but mapped to different B-VIDs may be forwarded over different paths (referred to as “multipath instances”) through the network. A customer data frame associated with a service is encapsulated in accordance with 802.1aq with a header that has a separate service identifier (I-SID) and B-VID. This separation permits the services to scale independently of network topology. Thus, the B-VID can then be used exclusively as an identifier of a multipath instance. The I-SID identifies a specific service to be provided by the multipath instance identified by the B-VID. EVPN is an Ethernet over MPLS VPN protocol solution that uses BGP to disseminate VPN and MAC information, and MPLS as the transport. The subtending 802.1.aq networks (referred to as SPBM-PBBNs) can be interconnected while operationally decoupling the SPBM-PBBNs, by minimizing (via need to know filtering) the amount of state, topology information, nodal nicknames and B-MACS that are leaked from BGP into the respective subtending SPBM-PBBN IS-IS control planes. mLDP

mLDP is multicast LDP documented in RFC 6388. mLDP permits the creation of P2MP and MP2MP multicast distribution trees. MP2MP has a concept of sender and receiver in the form of upstream and downstream forwarding equivalency classes (FECs). mLDP has both opaque and application specific (specified for interoperability) encodings of FEC elements to permit the naming of multicast groups. mLDP generally operates as a transactional multicast group management protocol that tracks the join and leave actions for each multicast group.

### 8021.aq SPBM

802.1aq Shortest Path Bridging MAC mode (SPBM) is a routed Ethernet solution based around the IS-IS routing protocol, the 802.1ah data plane and the techniques of a filtering database (FBD) populated by a management or control plane as is documented in 802.1Qay PBB-TE. 802.1aq substitutes computing power of network elements for control plane messaging, that is it leverages the computing power of the network elements to avoid the need for extensive control plan messaging. 802.1aq is efficient because the time required to perform both inter and intra node synchronization of state with the control plane messaging is significantly greater than the computational time at the network elements. The quantity of control plane messaging is reduced by orders of magnitude for O(services) or O(FECs) to O(topology change) This protocol significantly alters the paradigm for multicast. The protocol leverages Moore's Law to render obsolete the ordered multicast join/leave processes that were previously used due to lack of computing power. 802.1aq permits the application of multicast to the control plane as is utilized in the processes described further herein below.

### EVPN

EVPN is a BGP based Ethernet over MPLS networking model. It incorporates a number of advances over traditional “VPLS,” which is another method of doing Ethernet over MPLS. EVPN supports split LAG “active-active” uplinks. BGP is the mechanism of mirroring FDBs to eliminate the diverse “go-return” problem and permit the use of destination based forwarding in the EVPN overlay. If the “go” path is different than the “return” path for a data flow then traditional topology and path learning will not function properly, and frames will be continuously flooded. EVPN permits a greater degree of equal cost multi-path (ECMP) balancing across the core network. It consolidates the L2 and L3 VPN control plane onto BGP. Other characteristics of EVPN include that it uses MP2P labels instead of P2P thereby facilitating scalability. However, EVPN does not integrate MDT setup in the control plane, so it must be augmented by a multicast control protocol if the benefits of multicast are to be realized as described further herein below.

### SPBM and EVPN

A method and system for adding 802.1aq SPBM support to EVPN is described in U.S. patent application Ser. No. 13/594,076, which can be utilized in combination with the processes and systems described herein. PEs local to an ESI self elect as designated forwarders (DFs) for traffic associated with a given local B-VID such that there is only one DF per B-VID for a given ESI. The DF then is responsible for the interworking of all control plane (CP) and data plane (DP) associated traffic between SPBM and EVPN for the I-SIDs associated with that particular B-VID. The method selectively leaks IS-IS information into BGP and vice versa to provide relevant topology information to each network. However, the method and system introduced herein augment this system for adding 802.1aq SPBM support to EVPN by detailing how multicast support can be added to EVPN to improve multicast efficiency in the MPLS network.

### Concepts

The embodiments of the method and system for improved multicast efficiency rely on a number of aspects of the system design and related protocols that are highlighted here. Two site I-SIDs will use unicast forwarding for multicast traffic. Use cases for P2MP and MP2MP multicast trees exist. MP2MPrequires less state to be maintained, but can increase the probability of packet ordering problems. mLDP is assumed to be the signaling protocol for MPLS multicast herein, however other protocols with similar tree naming properties can be utilized. There can be use cases for both shared trees (n:1 I-SID:MDT) and service specific trees (1:1 I-SID:MDT). The method and system provide a mechanism for all potential members of a multicast group to register that interest in the control plane so that the required MDT or MDTs can be set up. The embodiments described herein assume this is established in such a way that it did not require a priori administration. However, a priori administration can be utilized. For example, mapping to a separate namespace is possible, but requires additional resources because this requires a mapping system to be maintained. A separate mapping system could be avoided if the nodes were configured with a priori generated mapping tables. It can be assumed that the EVPN BGP exchange disseminates sufficient information to PEs to permit this to be possible for a multicast control protocol.

The large number of possible trees that would require such an a priori mapping in a shared tree scenario would be prohibitive. To illustrate this, to determine the maximum number of possible multicast trees from a given site a number of possible destination sites is determined, which ranges from 2 up to the total number of sites −1. However, this must be expressed as combinations, e.g. “how many combinations of ‘k’ sites exist in the set of ‘n−1’ destination sites?” To compute this the sum for k=2 to n−1 of destination sites is calculated:

n=sites

m=PEs per site

P=possible S,G trees from a given site

$$P = {\sum }_{k = 2}^{k = n - 1} {m}^{k + 1} ( n - 1 ) ! / k ! ( n - 1 - k ) !$$

The result value has a high rate of growth with respect to the number of PEs. This indicates that the likelihood of two I-SIDs sharing a tree is small in scenarios with a large number of PEs and a priori indirect naming of all possible trees is prohibitively complex, e.g. administratively assigning each possible one an IP multicast address would be difficult.

The embodiments described herein below assume that mLDP joins and leaves decompose to specific label operations. These operations effectively proxy for join or leave transactions in other multicast protocols (e.g., offer, withdraw and similar operations). This can be on the basis of sender and receiver specific label operations, also dependent on the local media type (shared or p2p). For clarity, the following description of the embodiment refers to these as joins and leaves. One skilled in the art would understand the mechanics of these operations are actually executed as label operations.

### Multicast Distribution Tree Name Generation

The embodiments rely on a shared algorithm across all of the PEs for determining names for MDTs. With a shared naming process and shared network information via the local BGP and IS-IS databases at each PE, each PE can determine the same name for each MDT as tied to a particular I-SID. The naming convention can utilize any combination or order of unique identifiers for each multicast source and each multicast receiver. For names that are a concatenation of information elements, common rules are utilized for ranking the information elements so that regardless of which PE generates the information elements, the PE will produce a common result when injected into mLDP. Examples of names that could be utilized include a P2MP service specific name <RT, Source DF IP address, I-SID>, a Mp2MP service specific name <RT, I-SID>, a P2MP shared name <RT, Source DF IP address, <sorted list of leaf DF IP addresses>>, a MP2MP shared name <RT, <sorted list of leaf DF IP addresses>> and similar formats. Rules for sorting lists can be arbitrary as long as all nodes apply the same rules and the rules produce a consistent output given any arbitrary arrangement of a common set of input elements, e.g., sorted ascending, sorted descending, or similar arrangement.

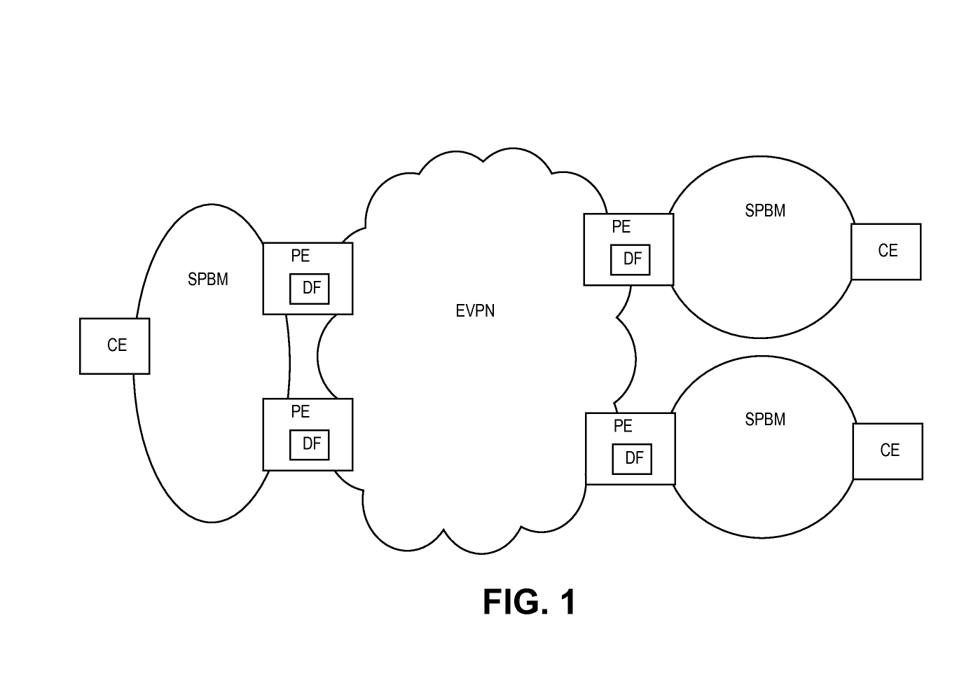

FIG. 1 is a diagram of one embodiment of an example EVPN—SPBM network implementing the enhanced multicast using mLDP. The network can include any number of customer edge equipment (CE) nodes that are devices that connect a local area network (LAN) or similar set of customer devices with the SPBM. The CE can be any type of networking router, switch, bridge or similar device for interconnecting networks.

The SPBM network is a set of network devices such as routers or switches forming a provider backbone network (PBBN) that implements shortest path bridging MAC mode. This network can be controlled by entities such as internet service providers and similar entities. The SPBM can be connected to any number of other SPBM, CE (via a BEB) or similar networks or devices over an EVPN (i.e., an IP/MPLS network) or similar wide area network. These networks can interface through any number of PEs. The modification of the PEs to support 802.1aq over EVPN within the SPBM are described further in U.S. patent application Ser. No. 13/594,076. The illustrated network of FIG. 1 is simplified for sake of clarity. One skilled in the art would understand that the network can have any number of CE, SPBM and PEs, where any given SPBM can connect with the EVPN network through any number of PEs.

The embodiments rely on control plane interworking in the PEs to map ISIS-SPB information elements into the EVPN NLRI information and vice versa. Associated with this are procedures for configuring the forwarding operations of the PEs such that an arbitrary number of EVPN subtending SPBMs may be interconnected without any topological or multi-pathing dependencies.

BGP acts as a common repository of the I-SID attachment points for the set of subtending PEs/SPBMs, that is to say the set of PEs and SPBMs that are interconnected via EVPN. This is in the form of B-MAC address/I-SID/Tx-Rx-attribute tuples stored in the local BGP database of the PEs. The CP interworking function filters the leaking of I-SID information in the BGP database on the basis of locally registered interest. Leaking as used herein refers to the selective filtering of what BGP information is transferred to the local IS-IS database.

Each SPBM network is administered to have an associated Ethernet Segment ID (ESI) associated with it. For each B-VID in an SPBM, a single PE is elected the designated forwarder (DF) for the B-VID. A PE may be a DF for more than one B-VID. This may be via configuration or via algorithmic process. In some embodiments the network is configured to ensure a change in the designated forwarder is only required in cases of PEs failure or severing from either the SPBM or EVPN network to minimize churn (i.e., the data load caused by BGP messaging and similar activity to reconfigured the network to utilize a different PE as the DF) in the BGP-EVPN.

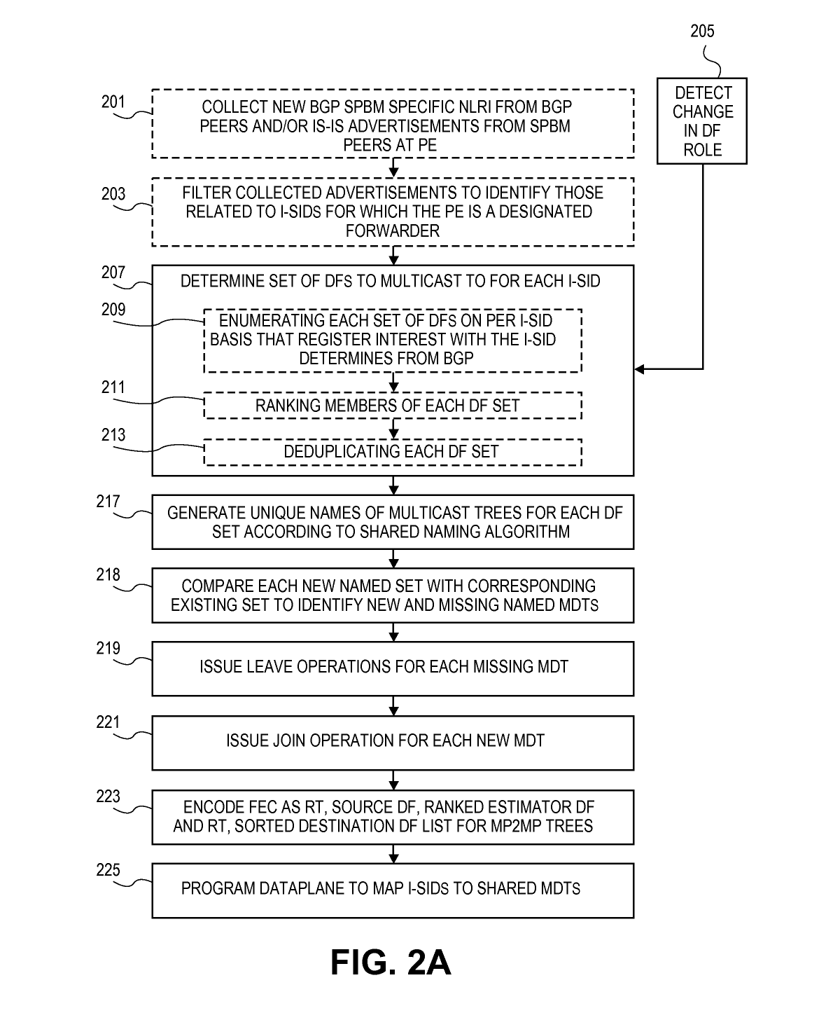

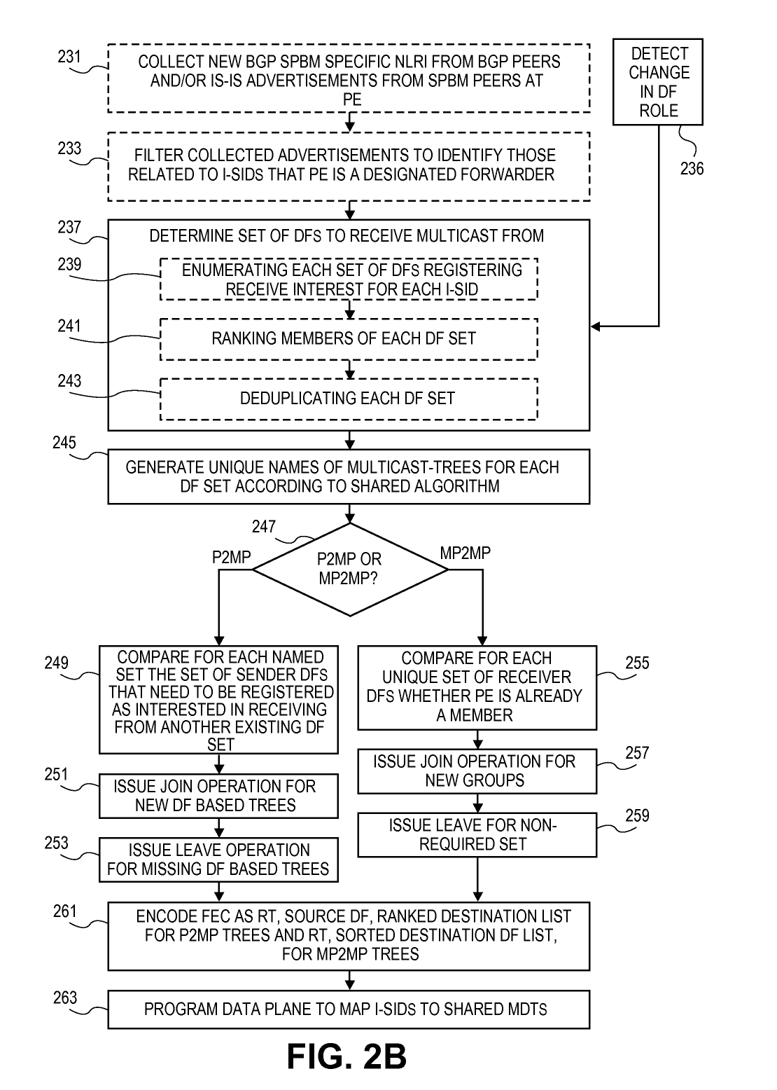

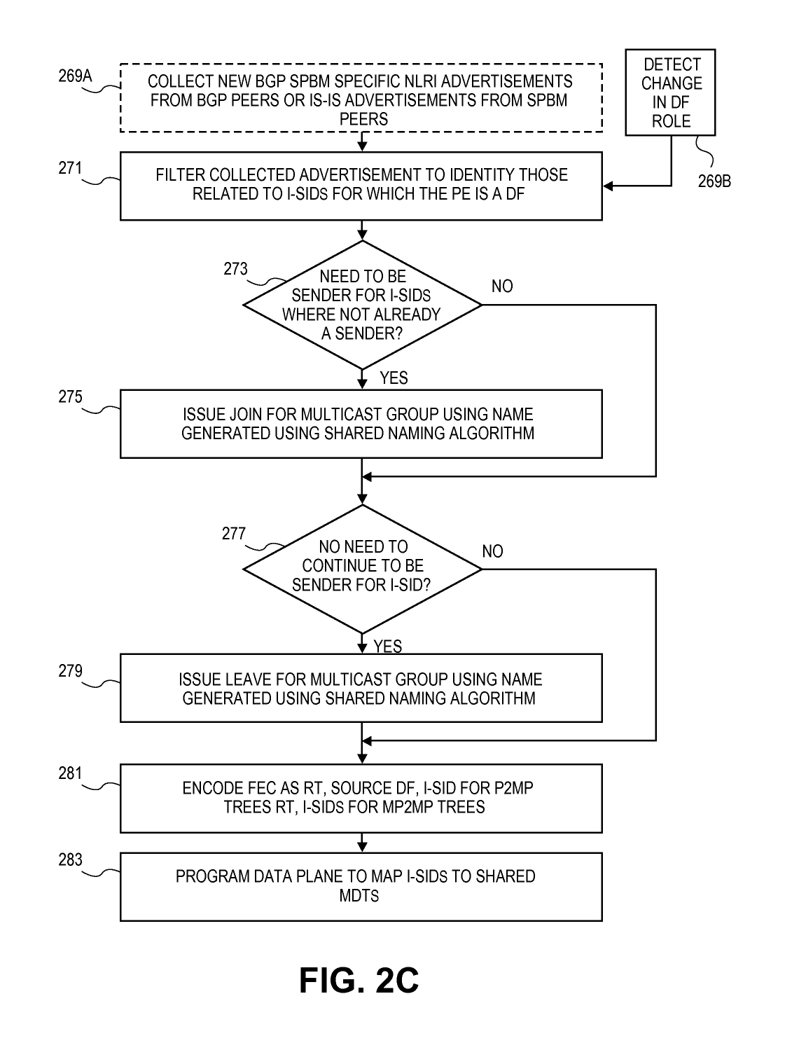

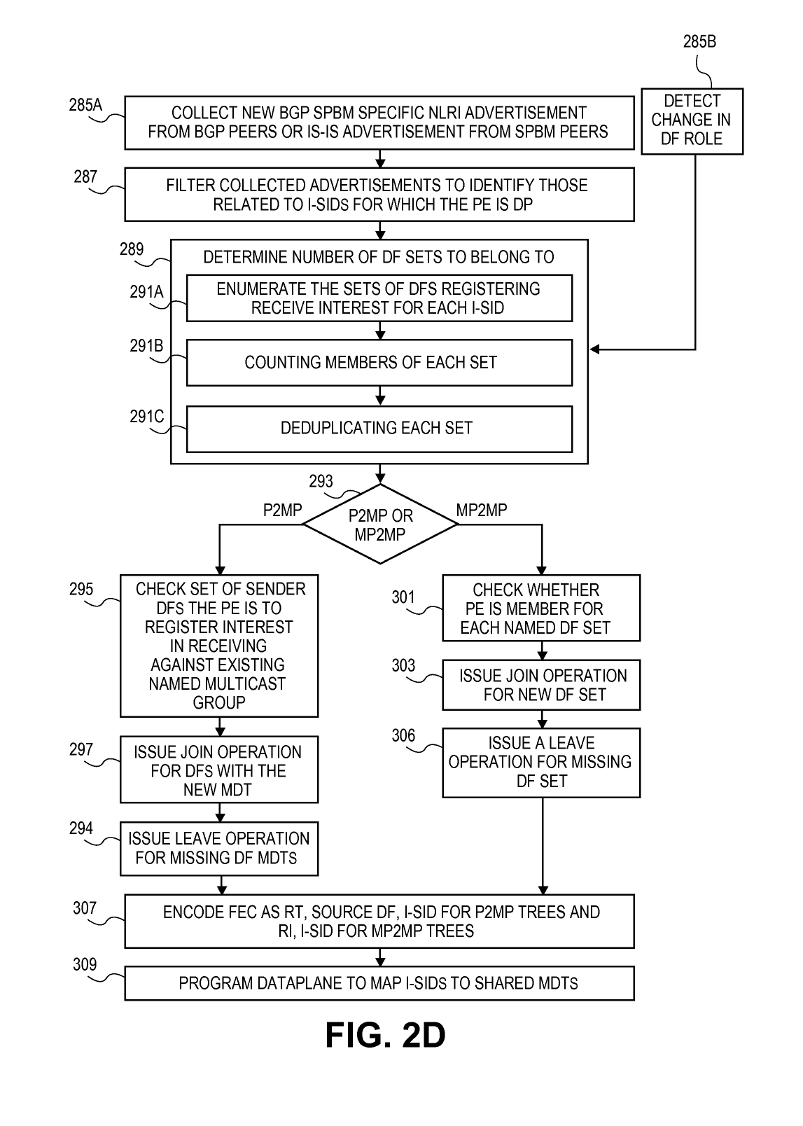

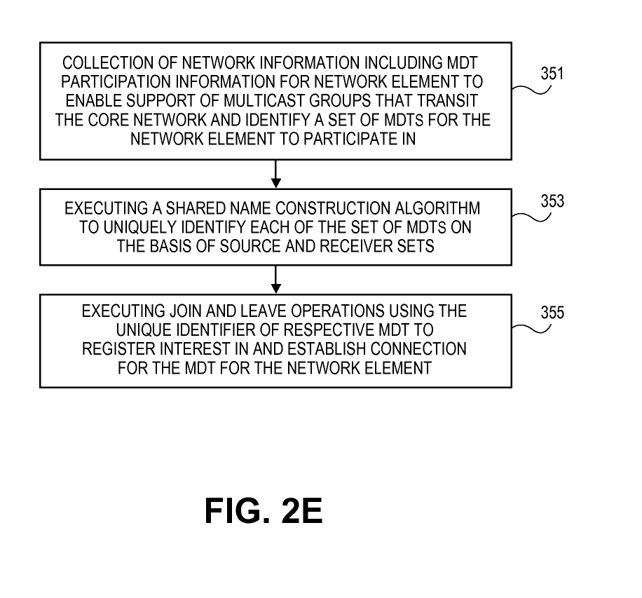

FIG. 2A is a diagram of one embodiment of the process for determining shared trees on the control plane by sending designated forwarders. This process is performed at each PE. Each PE has a pre-existing list of multicast memberships and a combination of network information that has already been distributed by both BGP and IS-IS. In one embodiment, the process is initiated when the PE collects new BGP SPBM specific NLRI advertisements from BGP peers and/or new IS-IS advertisements from SPBM peers (Block 201). The collected advertisements are filtered to identify those advertisements that are related to I-SIDs for which the PE is a designated forwarder (Block 203). In other embodiments or scenarios, the process can be initiated when there is a change in the DF roles in the attached networks, which can be caused by changes in network topology, multicast sources and similar circumstances (Block 205).

In either case, the PE determines a set of DFs that it needs to multicast to for each I-SID (Block 207). The PE can enumerate each set of DFs on a per I-SID basis that have registered an interest in the I-SID, which is determined from the BGP database information (Block 209). Each of the sets of DFs are then ranked (Block 211). The ranked sets of DFs can then be deduplicated (Block 213). The resulting sets of DFs can then be processed to determine unique names for the MDTs for each set of DFs using the name construction algorithm (Block 215). As discussed above, the name construction algorithm can use any process and name information encompassing unique multicast source and multicast receiver identifiers and similar information such as the I-SID.

The new named set of multicast groups can then be compared with an existing named set of multicast groups to identify new and missing MDTs (Block 217). Leave operations are executed for each missing MDT (Block 219). Join operations are executed for each new MDT that was detected in the comparison (Block 221). An FEC is encoded using for example RT (route target, which functions as a VPN ID), source DF, ranked destination DF for p2 mp trees and RT, sorted destination list for mp2 mp trees (Block 223. A route target is an identifier of the VPN encompassing the interconnected SPBM and EVPN networks. The data plane can then be programmed to map each I-SID to the associated MDT. The data plane can then be utilized as part of a quick lookup for further data plane processing.

FIG. 2B is a diagram of one embodiment of the process for determining shared trees on the control plane for receiving designated forwarders. This process is performed at each PE. Each PE has a pre-existing list of multicast memberships and a combination of network information that has already been distributed by both BGP and IS-IS. In one embodiment, the process is initiated when the PE collects new BGP SPBM specific NLRI advertisements from BGP peers and/or new IS-IS advertisements from SPBM peers (Block 231). The collected advertisements are filtered to identify those advertisements that are related to I-SIDs for which the PE is a designated forwarder (Block 233). In other embodiments or scenarios, the process can be initiated when there is a change in the DF roles in the attached networks, which can be caused by changes in network topology, multicast sources and similar circumstances (Block 235).

In either case, the PE determines a set of DFs that it needs to receive via multicast for each I-SID (Block 237). The PE can enumerate each set of DFs on a per I-SID basis that have registered a receive interest in the I-SID, which is determined from the BGP database information (Block 239). Each of the sets of DFs are then ranked (Block 241). The ranked set of DFs can be deduplicated (Block 243). The resulting sets of DFs can then be processed to determine unique names for the multicast groups or MDTs for each set of DFs using the name construction algorithm (Block 245). As discussed above, the name construction algorithm can use any process and name information encompassing unique multicast source and multicast receiver identifiers and similar information such as the I-SID.

The process then varies based on the type of multicast trees in use, p2 mp or mp2 mp which is then determined (Block 247). For p2 mp, the new named set of MDTs can then be compared with an existing named set of MDTs to identify new and missing MDTs (Block 249). Leave operations are executed for each missing MDT (Block 251). Join operations are executed for each new MDT that was detected in the comparison (Block 253). A FEC is encoded using for example RT (route target), source DF, ranked destination list for p2 mp trees and RT, sorted destination list for mp2 mp trees (Block 261). The data plane can then be programmed to map each I-SID to the associated MDT (Block 263). The data plane can then be utilized as part of a quick lookup for further data plane processing.

For p2 mp, the new named set of receiver DF sets can then be compared with an existing named set of MDTs to identify new and missing MDTs (Block 255). Leave operations are executed for each missing MDT (Block 257). Join operations are executed for each new MDT that was detected in the comparison (Block 259). A FEC is encoded using for example RT (route target), source DF, ranked destination list for p2 mp trees and RT, sorted destination list for mp2 mp trees (Block 261). The data plane can then be programmed to map each I-SID to the associated MDT (Block 263). The data plane can then be utilized as part of a quick lookup for further data plane processing.

Data Plane Function with Shared Trees

The PE maintains an internal mapping of I-SIDs to MDTs. When an Ethernet frame arrives that has a multicast destination address with the I-SID in it, it resolves to the specific MDT for the I-SID. There may be only one MDT per I-SID, multiple I-SIDs can map to a single MDT. The PE suitably MPLS encapsulates the frame for the MDT and sends copies of the encapsulated frame out on all required interfaces.

### DF Role Changes

The addition or removal of a DF from a tree effectively means a new tree will be created with the new algorithmically constructed name. DFs may be added or removed as a result of provisioning or failures of the node acting as the DF. For provisioning cases, a leisurely changeover is fine. However, for the latter prompt changeover is required. To minimize network disruption receivers can establish a period of overlap monitoring where both the old and new trees are in use. When a new join occurs a pre-defined or specified delay is instituted before the old tree is discarded or rendered. Senders only use one tree from the set of <old,new> trees to ensure no packet duplication.

FIG. 2C is a diagram of one embodiment of the process for determining service specific trees on the control plane for sending designated forwarders. This process is performed at each PE. Each PE has a pre-existing list of multicast memberships and a combination of network information that has already been distributed by both BGP and IS-IS. In one embodiment, the process is initiated when the PE collects new BGP SPBM specific NLRI advertisements from BGP peers and/or new IS-IS advertisements from SPBM peers (Block 269A). The collected advertisements are filtered to identify those advertisements that are related to I-SIDs for which the PE is a designated forwarder (Block 271). In other embodiments or scenarios, the process can be initiated when there is a change in the DF roles in the attached networks, which can be caused by changes in network topology, multicast sources and similar circumstances (Block 269B).

In either case, the PE determines a set of DFs that is needs send (multicast) to for each I-SID (Block 273). For each of these identified multicast groups a join operation can be issued using a name generated using the shared name construction algorithm (Block 275). As discussed above, the name construction algorithm can use any process and name information encompassing unique multicast source and multicast receiver identifiers and similar information such as the I-SID. A check can also be made to determine whether the PE needs to remain a sender for each I-SID (Block 277). A leave operation can be executed for each group that no longer needs to be sent to (Block 279) using the constructed unique name.

An FEC is encoded using for example RT (route target), source DF, and I-SID for p2 mp trees and RT, I-SID for mp2 mp trees (Block 281). The data plane can then be programmed to map each I-SID to the associated MDT (Block 283). The data plane can then be utilized as part of a quick lookup for further data plane processing.

FIG. 2D is a diagram of one embodiment of the process for determining service specific trees on the control plane for receiving designated forwarders. This process is performed at each PE. Each PE has a pre-existing list of multicast memberships and a combination of network information that has already been distributed by both BGP and IS-IS. In one embodiment, the process is initiated when the PE collects new BGP SPBM specific NLRI advertisements from BGP peers and/or new IS-IS advertisements from SPBM peers (Block 285A). The collected advertisements are filtered to identify those advertisements that are related to I-SIDs for which the PE is a designated forwarder (Block 287). In other embodiments or scenarios, the process can be initiated when there is a change in the DF roles in the attached networks, which can be caused by changes in network topology, multicast sources and similar circumstances (Block 285B).

In either case, the PE determines a set of DFs that it needs to receive multicast from for each I-SID (Block 289). The PE can enumerate each set of DFs on a per I-SID basis that have registered receiving interest in the I-SID, which is determined from the BGP database information (Block 291A). Each of the sets of DFs are then ranked (Block 291B). The ranked set of DFs can be deduplicated (Block 291C). The process then varies depending on whether the trees are p2 mp or mp2 mp trees (Block 293).

For p2 mp trees, a comparison is made of the set of sender DFs that the PE is to registered an interest in receiving against existing named MDTs (Block 295). Join operations are executed for each new MDT that was detected in the comparison (Block 297). Leave operations are executed for each missing MDT (Block 299). An FEC is encoded using for example RT (route target), source DF, I-SID for p2 mp trees and RT, I-SID for mp2 mp trees (Block 307). The data plane can then be programmed to map each I-SID to the associated MDT (Block 309). The data plane can then be utilized as part of a quick lookup for further data plane processing.

Data Plane Function with Service Specific Trees

The PE maintains an internal mapping of I-SIDs to MDTs on the basis of a direct mapping to multicast FEC. When an Ethernet frame arrives at the PE that has a multicast destination address with the I-SID in it, it resolves to the specific MDT for the I-SID. There may be only one MDT per I-SID. The PE suitably MPLS encapsulates the frame for the MDT and sends copies of the encapsulated frame out on all required interfaces.

FIG. 2E is a flowchart of one embodiment of a general multicast support process. The embodiments described herein below are related to example implementation of the concepts of the invention. These concepts have a broader and more general application to multicast network support. The concepts can be applied as a method for construction and advertisement of shared trees in a network core where each node has sufficient information to identify the set of MDTs it is required to participate in to support the multicast groups that transit the core. Employing algorithmic construction of the names of the MDTs on the basis of receiver set (and for S,G trees, the source), and then using established join/leave multicast procedures to register interest in and establish appropriate connectivity for the MDTs.

The general method can be implemented by any set of network elements that are each connected to a core network and an edge network. Each network element provides multicast support across the core network including the construction and advertisement of shared trees in the core network. Each network element collects network information (Block 351) including multicast distribution tree (MDT) participation information for the network element to enable support of multicast groups that transit the core network and identify a set of MDTs for the network element to participate in.

Each network element executes a shared name construction algorithm (Block 353) to uniquely identify each of the set of MDTs on the basis of source and receiver sets using any common format, information elements and order. The network elements execute join and leave operations (Block 355) that can be standard multicast group/subscription management function, using the unique identifier according to the shared name construction algorithm of a MDT to register interest in or establish connectivity for the MDT as it involves the network element.

Thus, this process can be utilized with any type of core network or edge network including where the core network is MPLS and the edge network is 802.1aq. The process can use any protocol or mechanism to distribute the network information such as network information that is disseminated by a combination of BGP and IS-IS. Similarly, multicast group registrations can be encoded in BGP and IS-IS.

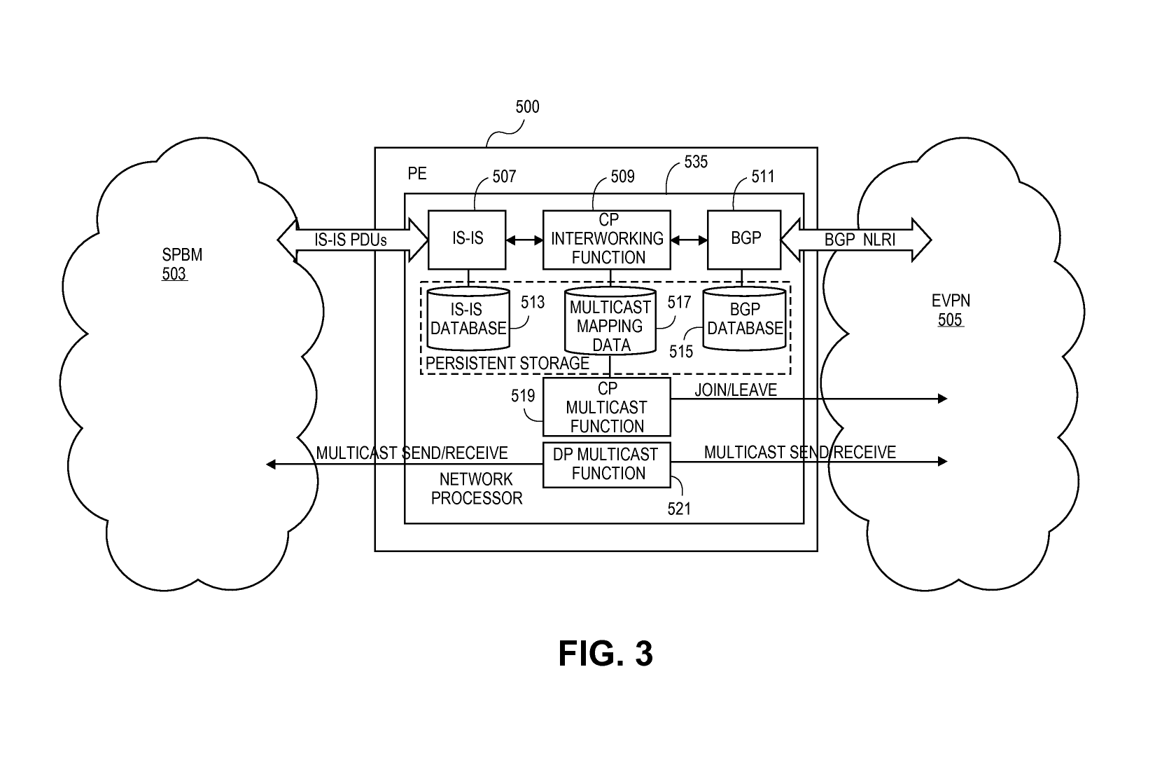

FIG. 3 is a diagram of one embodiment of a PE implementing the 802.1aq over EVPN and the improved multicasting. The PE 500 is connected through one interface with the SPBM 503 and through a second interface with the EVPN 505. The PE includes an IS-IS module 507, a control plane (CP) interworking function 509, a BGP module 511, an IS-IS database 513 and a BGP database 515, which implement the 802.1aq functionality. The multicasting functionality is implemented by a CP multicast function 519 and data plane (DP) multicast function 521 along with a multicast mapping database 517.

The IS-IS module receives and transmits IS-IS protocol data units (PDUs) over the SPBM to maintain topological and similar network information to enable forwarding of data packets over the SPBM. The BGP module similarly receives and transmits BGP PDUs and/or NLRI over the EVPN network interface to maintain topological and similar network information for the EVPN.

The CP interworking function exchanges information between the IS-IS module and BGP module to enable the proper forwarding of data and enable the implementation of 802.1aq over EVPN. The multicast mapping data contains the mapping of IS-IS information and BGP information (I-SID to MDT mappings). The CP multicast function issues joins and leaves for the EVPN. The DP multicast function sends and receives multicast data plane traffic. Each of these functions and databases can be implemented by a set of network processors 535 or is similarly implemented in the PE.

Control plane interworking ISIS-SPB to EVPN

When a PE receives an SPBM service identifier and unicast address sub-TLV as part of an ISIS-SPB MT capability TLV it checks if it is the DF for the B-VID in the sub-TLV. If it is the DF, and there is new or changed information then a MAC advertisement route NLRI is created for each new I-SID in the sub-TLV. The Route Distinguisher (RD) is set to that of the PE. The ESI is set to that of the SPBM. The Ethernet tag ID contains the I-SID (including the Tx/Rx attributes).

The DF election process is implemented by each PE. A PE self appoints in the role of DF for a B-VID for a given SPBM. An example but my no means the only possible process is implemented where the PE notes the set of RDs associated with an ESI. For each B-VID in the SPBM, the PE XORs the associated ECT-Mask (see section 12 of RFC 6329) with the assigned number subfield of the set of RDs and ranks the set of PEs by the assigned number subfield. If the assigned number subfield for the local PE is the lowest value in the set, then the PE is the DF for that B-VID. Note that PEs need to re-evaluate the DF role anytime an RD is added or disappears from the ESI for the RT.

The CP multicast function implements the CP functions for shared or service specific trees as described herein above issuing the appropriate join leave operations on the associated network interfaces with the SPBM and the EVPN. The CP multicast function maintains the I-SID to MDT mappings in the multicast mapping data. The CP also programs the data plane as needed to implement the forwarding according to the multicast group configuration determined by the CP multicast function. Similarly, the DP multicast function handles the actual receiving and forwarding of the multicast data using the multicast mapping data.

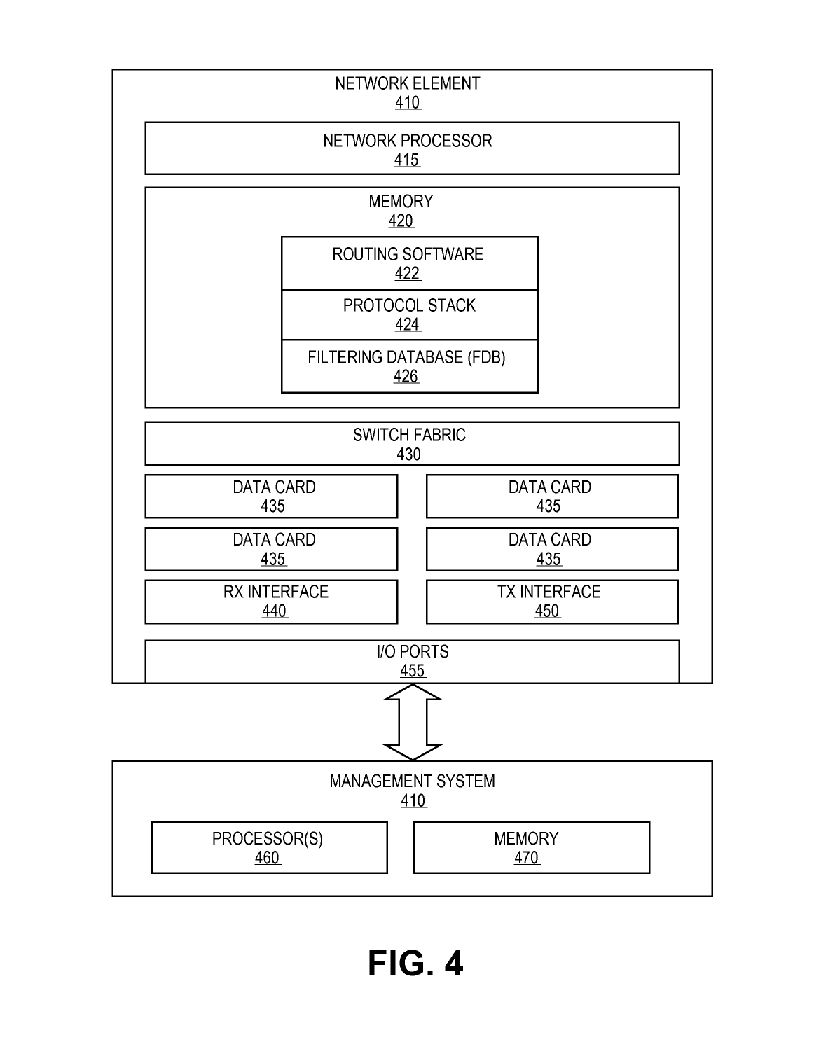

FIG. 4 illustrates an example a network element that may be used to implement an embodiment of the invention. The network element 410 may be any PE or similar device described above.

As shown in FIG. 4, the network element 410 includes a data plane including a switching fabric 430, a number of data cards 435, a receiver (Rx) interface 440, a transmitter (Tx) interface 450 and I/O ports 455. The Rx and Tx interfaces 440 and 450 interface with links within the network through the I/O ports 455. If the network element is an edge node, the I/O ports 455 also include a number of user-facing ports for providing communication from/to outside the network. The data cards 435 perform functions on data received over the interfaces 440 and 450, and the switching fabric 430 switches data between the data cards/I/O cards.

The network element 410 also includes a control plane, which includes one or more network processors 415 containing control logic configured to handle the routing, forwarding, and processing of the data traffic. The network processor 415 is also configured to perform split tiebreaker for spanning tree root selection, compute and install forwarding states for spanning trees, compute SPF trees upon occurrence of a link failure, populate a FDB 426 for data forwarding. Other processes may be implemented in the control logic as well.

The network element 410 also includes a memory 420, which stores the FDB 426 and a topology database 422. The topology database 422 stores a network model or similar representation of the network topology, including the link states of the network. The FDB 426 stores forwarding states of the network element 410 in one or more forwarding tables, which indicate where to forward traffic incoming to the network element 410.

In one embodiment, the network element 410 can be coupled to a management system 480. In one embodiment, the management system 480 includes one or more processors 460 coupled to a memory 470. The processors 460 include logic to configure the system IDs and operations of the network element 410, including update the system IDs to thereby shift work distribution in the network, assign priority to a subset of spanning trees such that non-blocking properties of the network are retained for at least these spanning trees. In one embodiment, the management system 480 may perform a system management function that computes forwarding tables for each node and then downloads the forwarding tables to the nodes. The system management function is optional (as indicated by the dotted lines); as in an alternative embodiment a distributed routing system may perform the computation where each node computes its forwarding tables.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented by a network element connected to a core network and an edge network, the network element providing multicast support across the core network including the construction and advertisement of shared trees in the core network, the method comprising the steps of:
collecting network information including multicast distribution tree (MDT) participation information for the network element to enable support of multicast groups that transit the core network and identify a required set of MDTs for the network element to participate in;
executing a shared name construction algorithm to uniquely identify each of the set of MDTs on the basis of source and receiver sets; and
executing join and leave operations using the unique identifier according to the shared name construction algorithm of a MDT to register interest in or establish connectivity for the MDT as it involves the network element.

2. The method of claim 1, wherein the core network is MPLS and the edge network is 802.1aq.

3. The method of claim 1, wherein the network information is disseminated by a combination of border gateway protocol (BGP) and intermediate system-intermediate system (IS-IS).

4. The method of claim 1, wherein multicast group registrations are encoded in border gateway protocol (BGP) and intermediate system-intermediate system (IS-IS).

5. A method of a process for construction of shared trees on the control plane for a set of designated forwarders (DFs), the process is performed at a provider edge (PE) where the PE may have a pre-existing list of multicast memberships and a combination of network information that has already been distributed by both border gateway protocol (BGP) and intermediate system intermediate system (IS-IS), the method comprising the steps of:
determining, by the PE, the set of DFs that the PE needs to multicast to for each I-component service identifier (I-SID);
processing the resulting sets of DFs to generate unique names for the multicast groups or multicast distribution trees (MDTs) for each set of DFs using a shared name construction algorithm;
comparing each new named set of multicast groups with a corresponding named set of multicast groups to identify new and missing MDTs;
executing leave operations for each missing MDT;
executing join operations for each new MDT that was detected in the comparison;
encoding a forwarding equivalency class (FEC) using route target, source DF, ranked destination DF for point to multi-point (p2 mp) trees and route target, sorted destination list for multi-point to multi-point (mp2 mp) trees; and
programming the data plane to map each I-SID to the associated MDT.

6. The method of claim 5, wherein determining the set of DFs that the PE needs to multicast to for each I-SID, further comprising the steps of:
collecting new BGP shortest path bridging media access control (MAC) mode (SPBM) specific network layer reachability information (NLRI) advertisements from BGP peers or new IS-IS advertisements from SPBM peers, the collected advertisements are filtered to identify those collected advertisements that are related to I-SIDs for which the PE is a designated forwarder.

7. The method of claim 5, wherein determining the DFs that the PE needs to multicast to for each I-SID, further comprises the steps of:
enumerating by the PE each set of DFs on a per I-SID basis that have registered an interest in the I-SID, which is determined from the BGP database information; and
ranking each of the sets of DF where a ranked set of DFs can be deduplicated.

8. The method of claim 5, wherein the route target is an identifier of a virtual private network (VPN) encompassing the interconnected SPBM and Ethernet VPN (EVPN) networks.

9. A network element connected to a core network and an edge network, the network element providing multicast support across the core network including the construction and advertisement of shared trees in the core network, the network element comprising:
a network processor configured a control plane interworking function and a control plane multicast function,
the control plane interworking function configured to map network information between the core network and the edge network, and
the control plane multicast function configured to collect network information including multicast distribution tree (MDT) participation information for the network element to enable support of multicast groups that transit the core network and identify a required set of MDTs for the network element to participate in and to execute a shared name construction algorithm to uniquely identify each of the set of MDTs on the basis of source and receiver sets, the control plane multicast function configured to execute join and leave operations using the unique identifier according to the shared name construction algorithm of a MDT to register interest in or establish connectivity for the MDT as it involves the network element.

10. The network element of claim 9, wherein the core network is MPLS and the edge network is 802.1aq.

11. The network element of claim 9, wherein the network information is disseminated by a combination of border gateway protocol (BGP) and intermediate system-intermediate system (IS-IS).

12. The network element of claim 9, wherein multicast group registrations are encoded in border gateway protocol (BGP) and intermediate system-intermediate system(IS-IS).

13. A network element functioning as a provider edge (PE) to implement a process for constructing shared trees on a control plane for a set of designated forwarders (DFs), where the PE may have a pre-existing list of multicast memberships and a combination of network information that has already been distributed by both border gateway protocol (BGP) and intermediate system—intermediate system (IS-IS), the provider edge comprising:
a network processor configured to execute an IS-IS module, a BGP module, a control plane interworking function and a control plane multicast function,
the IS-IS module configured to implement IS-IS for a SPBM,
the BGP module configured to implement BGP for an EVPN,
the control plane interworking function configured to correlated IS-IS and BGP data,
the control plane multicast function module configured to determine the set of DFs that the PE needs to multicast to for each I-component service identifier (I-SID), to process the resulting sets of DFs to generate unique names for the multicast groups or multicast distribution trees (MDTs) for each set of DFs using a shared name construction algorithm, to compare each new named set of multicast groups with a corresponding named set of multicast groups to identify new and missing MDTs, to execute leave operations for each missing MDT, to execute join operations for each new MDT that was detected in the comparison, to encode a forwarding equivalency class (FEC) using route target, source DF, ranked destination DF for point to multi-point (p2 mp) trees and route target, sorted destination list for multi-point to multi-point (mp2 mp) trees, and to program the data plane to map each I-SID to the associated MDT.

14. The network element functioning as the provider edge of claim 13, wherein the network processor is further configured to collect new BGP shortest path bridging media access control (MAC) mode (SPBM) specific network layer reachability information (NLRI) advertisements from BGP peers or new IS-IS advertisements from SPBM peers, the collected advertisements are filtered to identify those collected advertisements that are related to I-SIDs for which the PE is a designated forwarder.

15. The network element functioning as the provider edge of claim 13, wherein the network processor is further configured to enumerate each set of DFs on a per I-SID basis that have registered an interest in the I-SID, which is determined from the BGP database information, and to rank each of the sets of DF where a ranked set of DFs can be deduplicated.

16. The network element functioning as the provider edge of claim 13, wherein the route target is an identifier of a virtual private network (VPN) encompassing the interconnected SPBM and Ethernet VPN (EVPN) networks.
